(19) United States
(12) Patent Application Publication
(10) Pub. No.: US 2009/0112744 A1
(43) Pub. Date: Apr. 30, 2009

(54) System, Method, and Computer-Readable Medium for Mobile Loan Acquisition

(75) Inventors: Min Park, Garland, TX (US); Odes H. Kim, Irving, TX (US)

Correspondence Address: HAYNES AND BOONE, LLP;IP Section, 2323 Victory Avenue, Suite 700, Dallas, TX, 75219, US

(73) Assignee: MOBILEKASH, INC., Farmers Branch, TX (US)

(21) Appl. No.: 11/923,402

(22) Filed: Oct. 24, 2007

(51) Int. Cl. G06Q 40/00; G06Q 30/00

(52) U.S. Cl. 705/34; 705/38

(57) ABSTRACT

A system, method, and computer-readable medium that facilitate mobile acquisition of a loan are provided. A mobile loan system may communicatively interface with a financial institution that provides loans to mobile subscribers. A credit evaluation provider may evaluate the credit worthiness of the mobile terminal user based on a payment history of the mobile terminal account of the user. An insurance provider may issue an insurance policy against the loan to indemnify the loan provider. An invoice for the loan balance, and fees associated therewith, may be issued with the mobile terminal account service statement.

### BACKGROUND

The advent of mobile communication networks has opened many new mechanisms for finance and commerce. The mobile networks have been utilized to enable mobile users access to their bank accounts and make purchases real-time. Today's mobile phone customers can check their bank account balance, make transfers, and perform other banking tasks using their mobile phones. Products purchased with mobile payments have also become diverse, ranging from mobile content to vending machine items. Equally diverse are the mobile payment methods owing to the relatively new payment systems that can be implemented in many different ways. One of the payment methods for purchases using mobile phones is payment via the user's monthly mobile phone statement. This method allows users cashless and “credit-card-less” way to pay for their purchases.

Currently, the mobile phone's accessibility provides an advantage in reaching developing markets where the populace relies on cash for transactions. Technology where mobile phone turns into an electronic wallet that people can use to send and receive payments as well as make purchases has been recently introduced to these groups. This populace also is the primary obtainer of micro-loans (loans usually less than $1000) however obtaining loans using mobile phones have been limited for them due to the fact that a bank account is required. In addition, many people in this group do not have documented credit history adequate to obtain a loan.1 A method and system that provides a way for a mobile phone subscriber to obtain and repay a loan using his mobile phone account will greatly enhance the mobile purchase system especially for the un-banked mobile phone users.

In existing Mobile Payment Systems, the user makes a purchase at the point-of-sale (POS) terminal or website, and the POS sends a message including such information as the mobile phone number of the user to the mobile payment system for authentication. The payment system then verifies the mobile account subscriber and proceeds to authorize the purchase. In some implementations, the user may have a pre-paid account with a credit balance from which the merchandise price is deducted. The mechanism is referred to herein as a pre-paid transaction. In other implementations, the user may have a credit line, and the merchandise product price is applied to the user's credit line. The user may then receive a bill to settle the purchase. This mobile purchase mechanism is referred to herein as a post-paid transaction.

Heretofore, no mechanisms have been provided for acquiring a loan via a mobile platform. Further, many people that have mobile phone accounts do not have sufficiently documented credit. Disadvantageously, suitable credit lines for mobile-based loans may not be established for people that may otherwise be reasonable credit risks.

### BRIEF DESCRIPTION OF THE DRAWINGS

Aspects of the present disclosure are best understood from the following detailed description when read with the accompanying figures, in which:

FIG. 1 is a diagrammatic representation of a network system in which mobile purchases may be facilitated by micro-loan mechanisms implemented in accordance with an embodiment;

FIG. 2 is a diagrammatic representation of an exemplary Mobile loan system server that may be configured to facilitate mobile loan acquisitions in accordance with embodiments disclosed herein;

FIG. 3 is a diagrammatic representation of an exemplary user account database depicted in FIG. 1 that stores user mobile payment accounts that facilitates mobile loan acquisitions implemented in accordance with an embodiment;

FIG. 4 is a diagrammatic representation of a signaling flow that facilitates mobile loan acquisitions in accordance with an embodiment;

FIG. 5 is a diagrammatic representation of a signaling flow that facilitates mobile loan acquisitions in accordance with an alternative embodiment;

FIGS. 6A-6F are exemplary diagrammatic representations of mobile user equipment user interfaces that facilitate mobile loan acquisitions implemented in accordance with an embodiment; and

FIG. 7 is a flowchart that depicts processing a mobile purchase in which a mobile loan may be acquired in accordance with an embodiment.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

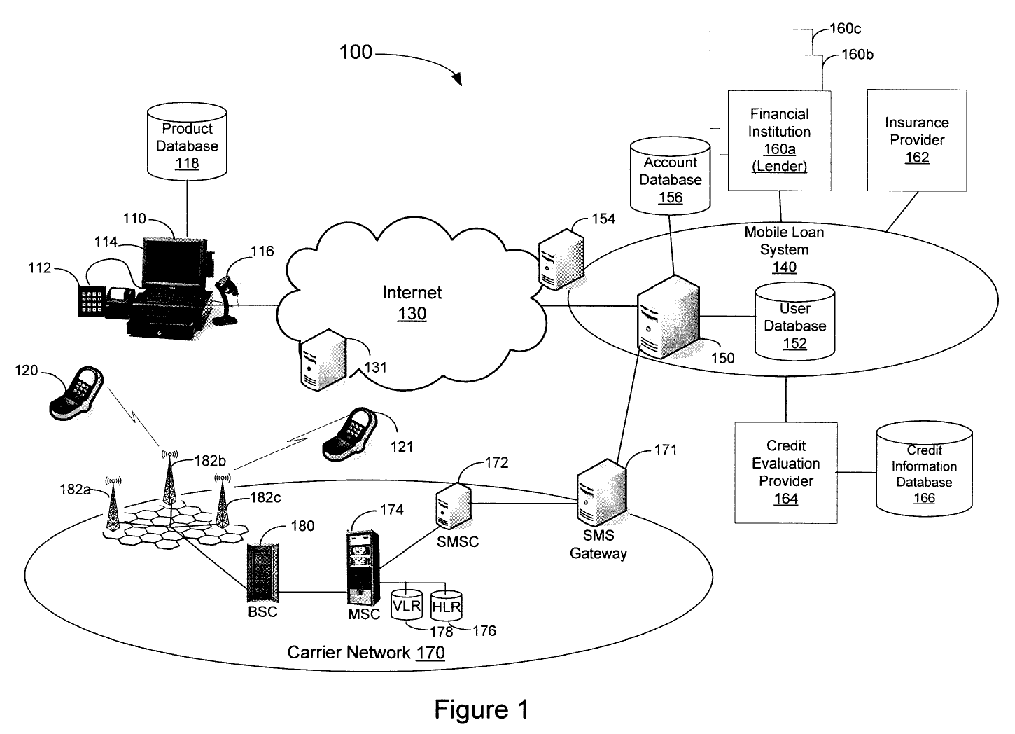

FIG. 1 is a diagrammatic representation of a network system 100 in which a mobile platform may be used to facilitate micro-loan acquisition mechanisms implemented in accordance with an embodiment. System 100 may optionally include a merchant point-of-sale (POS) terminal, referred to herein simply as POS 110. POS 110 may be implemented in a combination of hardware and software and may include a keypad 112 for user-supplied input, a display device 114 for visual output of transaction information including transaction status, and a product scanner 116, such as a laser scanner or CCD reader adapted to read product barcodes. In accordance with an embodiment, a product or service purchase may be made at POS 110 by a user with a mobile terminal 120 by acquiring a loan facilitated by the use of mobile terminal 120 as described more fully herein below.

POS 110 is communicatively coupled with a Mobile Loan System (MLS) 140, e.g., via a network such as the Internet 130. MLS 140 may be implemented as a data processing system, such as an MLS server 150, and is adapted to process mobile-originated loan requests. To this end, Mobile Loan System 140 may include or interface with a user database 152 that maintains records of users that are registered to make purchases via the mobile loan system. User records of database 152 may specify various account attributes, such as user names, phone numbers, authorization levels, and the like.

Mobile Loan System 140 is communicatively interfaced with a short message service (SMS) provider, such as a wireless carrier network 170. In the illustrative example, Mobile Loan System 140 is interfaced with carrier network 170 via an SMS gateway 171. SMS gateway 171 may be hosted by carrier network 170, or alternatively by an independent or third party SMS provider. SMS gateway 171 may be communicatively interfaced with an SMS Center (SMSC) 172 which may operate as a store-and-forward platform. SMSC 172 may interface with a mobile switching system, e.g., a mobile services switching center (MSC) 174. The mobile switching system may include or interface with a Home Location Register (HLR) 176, and a Visitor Location Register (VLR) 178. MSCs carry out switching functions and manage the communications between mobile phones and the Public Switched Telephone Network (PSTN). HLR 176 comprises the central database that contains details of each mobile phone user that is authorized to use the cellular core network. VLR 178 comprises a database which stores information about all the mobiles terminals that are currently serviced by the associated MSC. VLR 178 stores various information regarding the mobile terminals, such as the current location area identity that specifies a particular base station controller (BSC) that currently services the mobile phone. MSC 174 interfaces with a radio access network comprising a base station subsystem (BSS). In the illustrative example, the radio access network comprise a BSC 180 and various base transceiver stations (BTSs) 182a-182c operated under the control of BSC 180. BSC 180 manages and directs allocation of radio channels, receives measurements from the mobile phones, and controls handovers between BTSs among other functions. BTSs 182a-182c comprise one or more respective antenna and equipment for transmitting and receiving radio signals, and functions for encrypting and decrypting communications with BSC 180. BTSs 182a-182c provide for communications with mobile terminals, e.g., mobile terminals 120 and 121, over an air-interface.

Mobile loan system 140 may communicatively interface with a financial institution 160a that provides loans to mobile subscribers, an insurance provider 162 that insures mobile-originated loans, and a credit evaluation provider 164 that may evaluate a user's credit worthiness. A credit information database 166 may be accessible by credit evaluation provider 164. In an embodiment, credit information database 166 may maintain payment histories of mobile terminal service account to facilitate a credit evaluation based solely on the user's mobile terminal service payment history. In an alternative embodiment, credit evaluation provider 164 and credit information database 166 may be included within mobile loan system 140. Mobile loan system 140 may facilitate transmission of messages between various entities during a mobile loan acquisition. Additionally, a server 154 may be deployed in system 100 that allows mobile users to enroll in a mobile loan agreement for securing mobile loans. Server 154 may, for example, be hosted by mobile loan system 140.

In accordance with an embodiment, a user operating a mobile terminal, e.g., mobile terminal 121, may issue a request for a loan from mobile terminal 121. A loan acquired through a mobile terminal platform is herein referred to as a micro-loan. To facilitate loan acquisition, a mobile terminal may have an application, referred to as a wallet, hosted by the mobile terminal that maintains information regarding the user account(s) to which micro-loans may be directed, keys associated therewith, and other account information. Examples of user accounts may include bank accounts, stored value card accounts, and the user's mobile device account. Alternatively, a user wallet may be hosted by a network entity, such as wallet server 131, that is accessible by the mobile terminal, e.g., through wireless Internet access.

A credit evaluation may be requested and obtained in response to receipt of the mobile loan request. In accordance with an embodiment, a credit evaluation may be made based solely on the user's mobile account payment history. In the event the user has a sufficient credit rating for acquiring the loan, the loan may be approved, and the user may direct deposit of the loan into a financial account, e.g., a checking account, a credit card account, or other suitable financial account. In the event that the user does not have a sufficient credit rating, a guaranty insurance policy may be offered to the user that indemnifies the lender in the event the mobile user defaults on the loan. In an embodiment, an invoice for the loan balance may be issued with the mobile terminal account statement, e.g., in the mobile service monthly invoice. In a similar manner, fees associated with mobile loan insurance, if any, and a loan fee may be included in the mobile terminal service invoice. Alternatively, the loan balance may be issued directly to the mobile terminal user from the lender.

FIG. 1 is intended as an example network system, and not as an architectural limitation, in which embodiments disclosed herein may be implemented. While the descriptions of a carrier network architecture, and nomenclature related thereto, for transmission of an SMS message are made with reference to the Global System for Mobile (GSM) Communications, it is understood that this is done so for illustrative purposes only and that the network architecture on which embodiments disclosed herein may be applied is not limited to GSM but may be equivalently implemented on any variety of mobile communications systems. Network and device examples provided herein are illustrative only and implementations of the disclosed embodiments are not limited to any particular network, network-compliant device, or network communication formats or protocols. Furthermore, the description and illustration of SMS messaging as a transmission medium for communications between Mobile Loan System 140 and mobile terminals 120-121 is illustrative only, and various other messaging systems may be substituted therefore. For example, messaging transmissions from Mobile Loan System 140 to mobile terminals 120-121 may be made via Unstructured Supplementary Service Data (USSD) via a signaling channel or another suitable messaging mechanism.

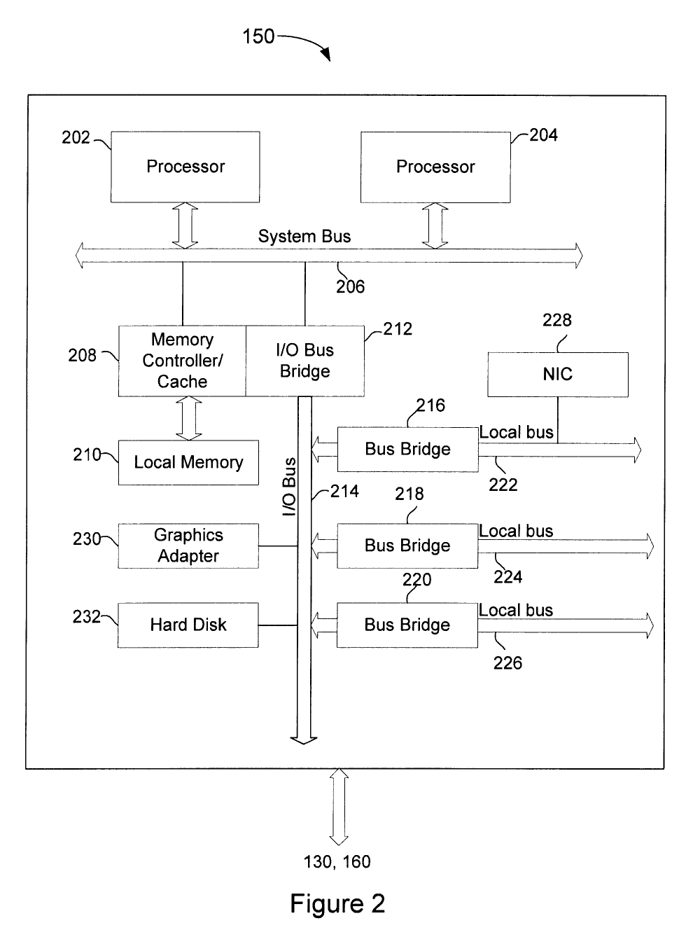

FIG. 2 is a diagrammatic representation of an exemplary Mobile Loan System server 150 that may be configured to facilitate mobile loan acquisitions in accordance with embodiments disclosed herein.

MLS server 150 may be a symmetric multiprocessor (SMP) system that includes a plurality of processors 202 and 204 connected to a system bus 206 although other single-processor or multi-processor configurations may be suitably substituted therefor. A memory controller/cache 208 that provides an interface to local memory 210 may also be connected with system bus 206. An I/O bus bridge 212 may connect with system bus 206 and provide an interface to an I/O bus 214. Memory controller/cache 208 and I/O bus bridge 212 may be integrated into a common component.

A bus bridge 216, such as a Peripheral Component Interconnect (PCI) bus bridge, may connect with I/O bus 214 and provide an interface to a local bus 222, such as a PCI local bus. Communication links to other network nodes of system 100 in FIG. 1 may be provided through a network interface card (NIC) 228 connected to local bus 222 through add-in connectors. Additional bus bridges 218 and 220 may provide interfaces for additional local buses 224 and 226 from which peripheral or expansion devices may be supported. A graphics adapter 230 and hard disk 232 may also be connected to I/O bus 214 as depicted.

Those of ordinary skill in the art will appreciate that the hardware depicted in FIG. 2 may vary. The depicted example is not intended to imply architectural limitations with respect to implementations of the present disclosure.

In accordance with an embodiment, a user may connect with a mobile online site, e.g., provisioned by server 154, to request a loan and agree to terms of the loan. The customer may be requested to set up an account or input a password to allow information, such as the customer's phone number and wallet, mobile phone memory, mobile phone chip, or PKI key existing in the network, to be obtained by server 154.

A request for customer information may be made where the personal information entered during the loan application is transmitted to the customer's mobile network provider, and information maintained by the network provider, such as a customer verification and limit to be sent to server 154, is requested. For example, mobile loan system 140 may operate as the user's mobile network operator. A request for a credit evaluation may then be made. To this end, the mobile phone number may be sent to credit evaluation provider 164 for a credit worthiness evaluation, e.g., based on a payment history associated with the mobile phone number. A request for loan approval process may then commence after a credit evaluation result is received from credit evaluation provider 164.

If the lender determines the user is a high credit risk, the lender may elect to request the user to purchase insurance for the loan. To this end, an SMS message may then be transmitted to mobile terminal 120 via carrier network 170. The SMS message may include a uniform resource locator (URL) or an application, such as a wireless application protocol (WAP) application, that functions to link mobile terminal 120 with insurance provider 162. The user may then purchase the loan insurance thereby protecting the lender from a potential loss resulting from a default on the loan.

Financial institution 160a that supplies the loan funds may then add credit information of the user to credit information database 166 of credit evaluation provider 164 that is used for credit evaluations. Assuming the loan is approved, a loan approval result notification may be transmitted to mobile terminal 120 for display thereby. The loan approval notification may, for example, comprise an SMS message with a URL or WAP application that when selected results in a request for a loan deposit in which case financial institution 160a receives a request or the loan amount to be deposited to the customer's new or existing account in a bank, e.g., a financial institution 160b, a pre-paid merchant's account, a pre-paid account provided by mobile loan system 140, a credit card account managed by a credit institution 160c, or another suitable account. The purchase transaction may then be completed with the loaned funds.

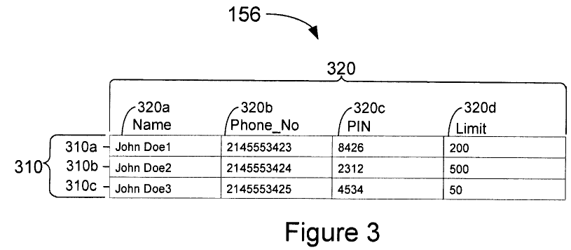

FIG. 3 is a diagrammatic representation of an exemplary user account database 156 depicted in FIG. 1 that stores user mobile payment account information that facilitates mobile loan acquisition implemented in accordance with an embodiment. In the illustrative example, account database 156 comprises a table although other data structures may suitably be substituted therefor.

Account database 156 comprises a plurality of records 310a-310c (collectively referred to as records 310) and fields 320a-320e (collectively referred to as fields 320). Database 156 may be stored on a disk drive, fetched therefrom by a processor, e.g., of Mobile loan system 140, and processed thereby.

In the present example, fields 320a-320d have labels of “Name”, “Phone_No”, “PIN”, and “Limit”. Name field 320a stores user names that are registered for mobile loan acquisitions via Mobile Loan System 140. In the present example, records 310a-310c are allocated for users “John Doe1”-“John Doe3”. Phone_No field 320b stores a mobile phone number assigned to the user of a corresponding record. PIN field 320c stores user PINs associated with a mobile phone of a respective record. In the illustrative example, PINs of “8426”, “2312”, and “4534” are assigned to mobile phones with numbers specified in field 320b of a corresponding record. Limit field 320d may specify a monetary limit of loans that may be extended to a user of an associated phone. For example, the phone having the phone number 2145553423 has a limit of “200” dollars. The phone having the phone number 2145553424 has a limit of “500” dollars, and the phone having the phone number 2145553425 has a limit of “50” dollars. The loan limit specified by Limit field 320d may comprise a monthly loan limit, a daily loan limit, or another suitable interval-based loan limit. When a loan is successfully made, the limit specified for the mobile phone from which the loan was acquired may be deducted by the loan amount. Records 310 may additionally include payment histories associated with the mobile terminal phone numbers, e.g., monthly mobile service invoice amounts, payments received, dates of payments, etc.

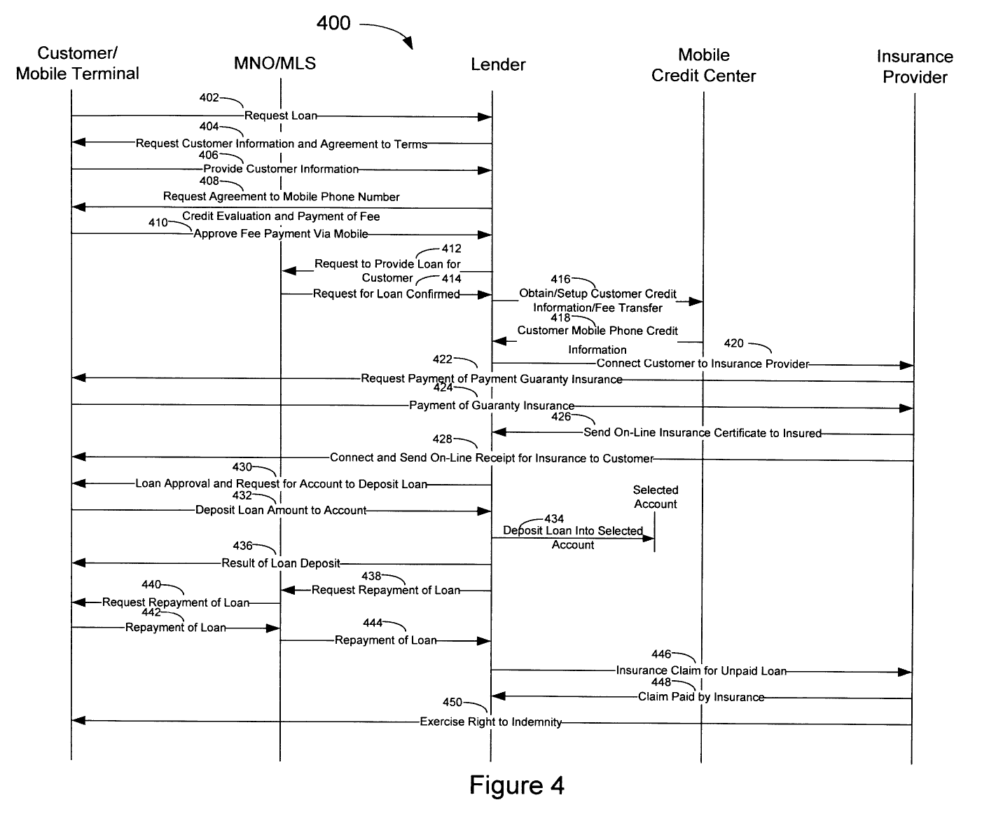

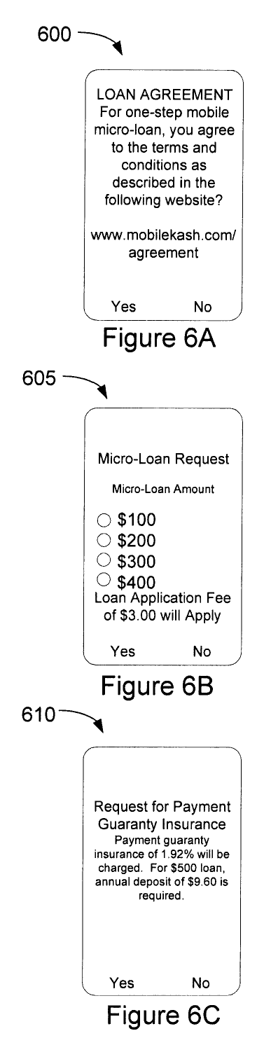

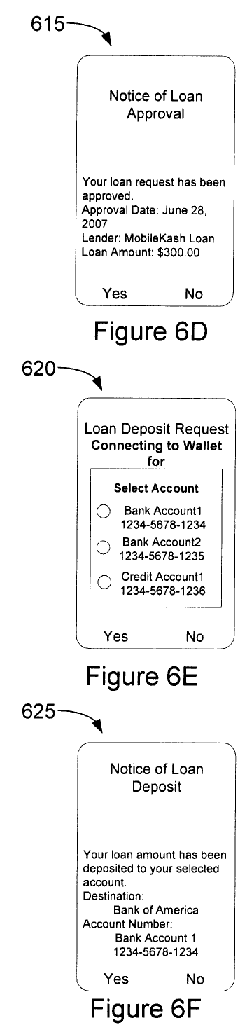

FIG. 4 is a diagrammatic representation of a signaling flow 400 that facilitates a mobile loan acquisition (e.g., Micro-Loan Process) in accordance with an embodiment. A loan request may be transmitted from a mobile terminal to a lender (step 402), e.g., financial institution 160a. The loan may be requested through SMS or other applications such as WAP and J2ME. Transmission of the loan request may optionally be communicated from the customer mobile terminal to the mobile loan system and conveyed to the lender thereby. For example, the user of mobile terminal 120 may access MLS server 150 via wireless Internet access, and may request a loan. A request for customer information and an agreement to terms may then be transmitted to the customer from the lender or mobile loan system (step 404). For example, the mobile terminal may receive a loan agreement consent form as displayed by the exemplary mobile terminal user interface 600 depicted in FIG. 6A. User interface 600 may include user-selectable options that allow the user to either accept or reject the loan agreement. The user interface may also include a request for customer information such as the customer's phone number, mobile account number, and/or other information. In the present example, assume the customer agrees to the terms and provides the requested information to the lender (step 406). A request for an agreement to a credit evaluation and payment of a corresponding loan fee may then be transmitted to the mobile terminal (step 408). The request for agreement to the loan may also include a request for a particular loan amount as indicated by the exemplary user interface 605 depicted in FIG. 6B. The user may then either accept or reject the request for the credit evaluation and fee. In the present example, assume the user approves the fee and provides authorization for the credit evaluation (step 410). The lender then may transmit a request to provide a loan for the customer to the mobile loan system (step 412), and the mobile loan system may reply with a confirmation (step 414).

The lender may then submit a request for credit information associated with the mobile phone number to credit evaluation provider 164 (step 416), and the lender subsequently receives the credit evaluation from the credit evaluation provider (step 418). Lender 160a may then connect the mobile terminal with the insurance provider 162 (step 420). The insurance provider may then transmit a request for payment of a payment guaranty insurance for the purchase in the event the user's credit rating requires issuance of an insurance policy (step 422) as indicated by the exemplary user interface 610 depicted in FIG. 6C. The user may either accept or reject payment of the insurance. If the loan is rejected based on the credit evaluation of the user or if the user rejects the payment of insurance, the session may be terminated after notifying the user. In the present example, assume the user accepts the payment for insurance (step 424). In this instance, the insurance provider transmits an on-line insurance certificate to the insured (step 426), e.g., the lender which is thereby insured against default of payment of the loan. The insurance provider may also send an on-line receipt for the insurance purchase to the customer (step 428).

On receipt of the insurance certificate, the lender may send a loan approval notification to the user as indicted by the user interface 615 of FIG. 6D and a request for an account identification for deposit of the loan as indicated by the user interface 620 of FIG. 6E (step 430). Selection of a financial account may be facilitated by a wallet application hosted by the mobile terminal, or a network wallet server 131. The user may then select an account for deposit of the loan, and a message indicating the user's selection is transmitted to the lender (step 432). The loan may then be deposited in the selected account by the lender (step 434). A notification of the loan deposit may then be transmitted from the lender to the user (step 436) as indicted by the user interface 625 of FIG. 6F.

A request for repayment of the loan may then be conveyed to the mobile loan system or mobile network operator (step 438), which in turn submits a corresponding request to the user (step 440), e.g., included in the user's monthly mobile service invoice. The user may then submit payment to the mobile loan system or mobile network operator (step 442) which in turn reimburses the lender (step 444).

In the event that the loan is not paid by the user, an insurance claim for the unpaid loan may be submitted by the lender to the insurance provider (step 446) which, in turn, reimburses the lender for the loan amount in default (step 448). The insurance provider may then exercise the right to indemnity with the user (step 450).

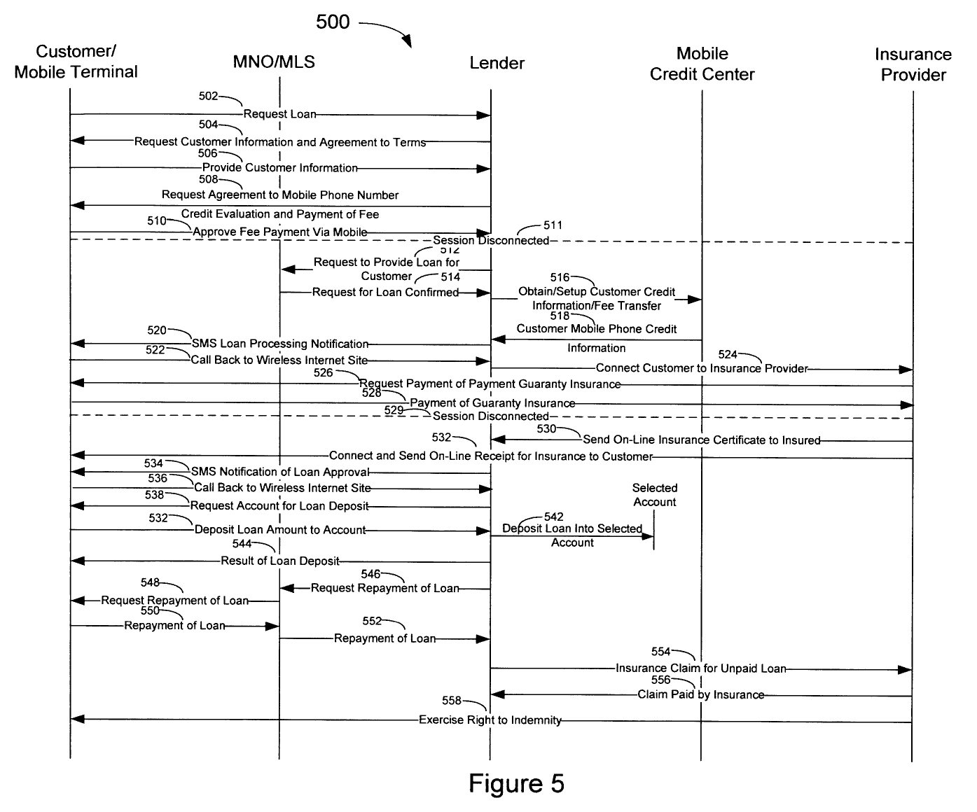

FIG. 5 is a diagrammatic representation of a signaling flow 500 that facilitates mobile loan acquisition (e.g., Micro-Loan Process) in accordance with an alternative embodiment. A loan request may be transmitted from a mobile terminal to a lender (step 502), e.g., financial institution 160a. The loan may be requested through SMS or other applications such as WAP and J2ME. Transmission of the loan request may optionally be communicated from the customer mobile terminal to the mobile loan system and conveyed to the lender thereby. A request for customer information and an agreement to terms may then be transmitted to the customer from the lender or mobile loan system (step 504). The request for customer information may include, for example, the customer's phone number, mobile account number, and/or other information. In the present example, assume the customer agrees to the terms and provides the requested information to the lender (step 506). A request for an agreement to a credit evaluation and payment of a corresponding loan fee may then be transmitted to the mobile terminal (step 508). The user may then either accept or reject the request for the credit evaluation and fee. In the present example, assume the user approves the fee and provides authorization for the credit evaluation (step 510). The session may then be disconnected while the customer waits for an SMS reply of the loan request process (step 511). The lender then may transmit a request to provide a loan for the customer to the mobile loan system (step 512), and the mobile loan system may reply with a confirmation (step 514).

The lender may then submit a request for credit information associated with the mobile phone number to credit evaluation provider 164 (step 516), and the lender subsequently receives the credit evaluation from the credit evaluation provider (step 518). The lender may then transmit an SMS message to the mobile terminal to notify the customer of the loan processing (step 520), and the mobile terminal may, responsive to receipt of the SMS message, call back or reconnect with the wireless Internet site (step 522). Lender 160a may then connect the mobile terminal with the insurance provider 162 (step 524). The insurance provider may then transmit a request for payment of a payment guaranty insurance for the loan (step 526). The user may either accept or reject payment of the insurance. If the loan is rejected based on the credit evaluation of the user or if the user rejects the payment of insurance, the session may be terminated after notifying the user. In the present example, assume the user accepts the payment for insurance (step 528). The session with the mobile terminal may then be disconnected (step 529), and the insurance provider may transmit an on-line insurance certificate to the insured party (step 530), e.g., the lender which is thereby insured against default of payment of the loan. The insurance provider may also send an on-line receipt for the insurance purchase to the customer (step 532). The lender may then transmit an SMS message to the mobile terminal that provides notification of the loan approval (step 534), and the mobile terminal may then make a call back or reconnection with the wireless Internet site (step 536). The lender may then send a request for an account identification for deposit of the loan to the mobile terminal (step 538). The user may then select an account for deposit of the loan, and a message indicating the user's selection is transmitted to the lender (step 540). The loan may then be deposited in the selected account by the lender (step 542). A notification of the loan deposit may then be transmitted from the lender to the mobile terminal (step 544).

A request for repayment of the loan may then be conveyed to the mobile loan system or mobile network operator (step 546), which in turn submits a corresponding request to the user (step 548). The user may then submit payment to the mobile loan system or mobile network operator (step 550) which in turn reimburses the lender (step 552).

In the event that the loan is not paid by the user, an insurance claim for the unpaid loan may be submitted by the lender to the insurance provider (step 554) which, in turn, reimburses the lender for the loan amount in default (step 556). The insurance provider may then exercise the right to indemnity with the user (step 558).

In accordance with another embodiment, a micro-loan may be acquired to facilitate a product purchase. A user operating a mobile terminal, e.g., mobile terminal 120, may submit a product for purchase at POS 110. A product ID is obtained by POS 110, e.g., via product scanner 116. A product price may additionally be obtained by POS, e.g., via a query made with product database 118 included or interfaced with POS 110. Product database 118 maintains product descriptions which may include product IDs, price, or other descriptive information. The product descriptions may be associated with respective product identifiers (PIDs) additionally stored in product database 118. Product identifiers may comprise universal product codes (UPCs) obtained from barcodes or other product identifiers. The user may then enter the user's phone number and personal identification number (PIN) at POS 110, e.g., via keypad 112, to facilitate a mobile purchase of the product.

The PID, product price, and user information including the user's mobile phone number may then be transmitted to mobile loan system 140. In accordance with an embodiment, a loan may be secured using mobile terminal 120 to complete the transaction. A loan may be requested if the user has a pre-paid account, and the pre-paid balance is insufficient for the product purchase. In a similar manner, a loan may be secured on behalf of post-paid users for a product purchase in the event the product price exceeds the post-paid user's credit line. An additional fee may be secured that is used to purchase insurance for a lender that extends the loan to the mobile user.

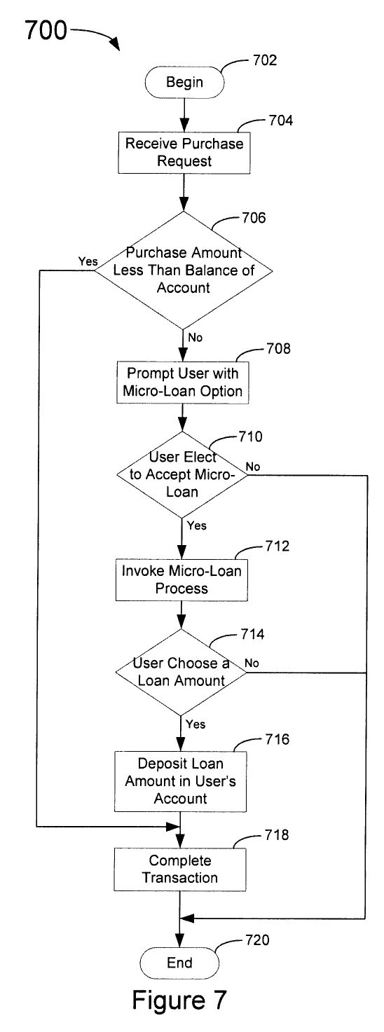

FIG. 7 is a flowchart 700 that depicts processing a mobile purchase routine in which a mobile loan may be acquired in accordance with an embodiment.

The mobile purchase routine is invoked (step 702), and a purchase request is received (step 704). An evaluation is then made to determine if the purchase amount of the product is less than then user's account balance or limit (step 706). If the purchase amount is less than the user's account balance, the purchase may be completed and the account balance deducted accordingly (step 718). Returning again to step 706, in the event that the purchase amount is not less than the account balance thereby indicating that the user either has a pre-paid balance less than the product purchase price, or the user has a credit line less than the product purchase price, the mobile purchase routine may then proceed to prompt the user with a micro-loan option (step 708). The micro-loan prompt informs the user that either the user's pre-paid funds are insufficient for the product purchase or the user's credit line is insufficient for the product purchase, and indicates a loan may possibly be acquired to purchase the product. The loan prompt may additionally include a selectable option to either refuse the loan or agree to a loan. An evaluation may then be made to determine if the user has elected to accept the micro-loan (step 710). If the user does not accept the micro-loan, the product purchase may be denied and the mobile purchase routine may end according to step 720. If it is determined that the user elects to acquire a loan for the product purchase, the Micro-Loan Process is invoked (step 712) and may be implemented in a similar manner as described above with reference to FIGS. 4 and 5. The micro-loan process may secure a loan amount on behalf of the user, and the user may then be prompted to choose the loan amount for the product purchase. An evaluation may then be made to determine if the user selected a loan amount (step 714). If it is determined that the user did not accept a loan amount, the product purchase may be denied and the mobile purchase routine may then end according to step 720. If the user accepts the loan amount, the loan may be deposited into the user account (step 716), and the transaction may then be completed by deducting the purchase price from the user's account according to step 718. The mobile purchase routine may then terminate according to step 720.

As described, embodiments disclosed herein provide mechanisms for mobile acquisition of a loan. A mobile loan system may communicatively interface with a financial institution that provides loans to mobile subscribers. A credit evaluation provider may evaluate the credit worthiness of the mobile terminal user based on a payment history of the mobile terminal account of the user. An insurance provider may issue an insurance policy against the loan to indemnify the loan provider. An invoice for the loan balance, and fees associated therewith, may be issued with the mobile terminal account service statement.

A user operating a mobile terminal may submit a product for purchase at a point of sale terminal. A product price and user information including the user's mobile phone number are then transmitted to a mobile loan system. A loan may be secured using the mobile terminal to complete the transaction if the user has a pre-paid account, and the pre-paid balance is insufficient for the product purchase. In a similar manner, a loan may be secured on behalf of a post-paid user for a product purchase in the event the product price exceeds the post-paid user's credit line. An additional fee may be secured that is used to purchase insurance for a lender that extends the loan to the mobile user.

The flowchart of FIG. 7 depicts process serialization to facilitate an understanding of disclosed embodiments and is not necessarily indicative of serialization of the operations being performed. In various embodiments, the processing steps described in FIG. 7 may be performed in varying order, and one or more depicted steps may be performed in parallel with other steps. Additionally, execution of some processing steps of FIG. 7 may be excluded without departing from embodiments disclosed herein.

Aspects of the present invention may be implemented in software, hardware, firmware, or a combination thereof. The various elements of the system, either individually or in combination, may be implemented as a computer program product tangibly embodied in a machine-readable storage device for execution by a processing unit. Various steps of embodiments of the invention may be performed by a computer processor executing a program tangibly embodied on a computer-readable medium to perform functions by operating on input and generating output. The computer-readable medium may be, for example, a memory, a transportable medium such as a compact disk, a floppy disk, or a diskette, such that a computer program embodying the aspects of the present invention can be loaded onto a computer. The computer program is not limited to any particular embodiment, and may, for example, be implemented in an operating system, application program, foreground or background process, driver, network stack, or any combination thereof, executing on a single computer processor or multiple computer processors. Additionally, various steps of embodiments of the invention may provide one or more data structures generated, produced, received, or otherwise implemented on a computer-readable medium, such as a memory.

Although embodiments of the present disclosure have been described in detail, those skilled in the art should understand that they may make various changes, substitutions and alterations herein without departing from the spirit and scope of the present disclosure.

What is claimed is:

1. A method of electronic commerce comprising:
receiving a loan request from a mobile device associated with a mobile device account, the loan request including a user loan authorization;
receiving a financial institution approval of the loan request;
transmitting to the mobile device a notice of the financial institution approval of the loan request;
depositing a loan amount of the loan request into a user account;
generating a billing statement for at least a portion of the loan amount; and
sending the billing statement to a user associated with the mobile device account.

2. The method of claim 1 further comprising:
receiving from the mobile device an account selection notice identifying the user account from among a plurality of accounts.

3. The method of claim 2 wherein the plurality of accounts includes a user bank account.

4. The method of claim 2 wherein the plurality of accounts includes a user stored value card account.

5. The method of claim 2 wherein the plurality of accounts includes the mobile device account.

6. The method of claim 1 further comprising:
transmitting, to the mobile device, an offer to purchase an insurance policy,
wherein the step of depositing a loan amount of the loan request into a user account is responsive to receiving an acceptance of the offer to purchase the insurance policy.

7. The method of claim 1 further comprising:
initiating a credit evaluation of a user of the mobile device responsive to receipt of the loan request, wherein the credit evaluation comprises an evaluation of a payment history of a mobile service account of the mobile device.

8. A method of acquiring a loan over a mobile platform, comprising:
receiving a loan request from a mobile device;
invoking a credit evaluation of a user of the mobile device responsive to receipt of the loan request, wherein the credit evaluation comprises an evaluation of a payment history of a mobile service account of the mobile device;
transmitting a request for an account identifier to the mobile device; and
depositing a loan amount of the loan request into an account having the account identifier.

9. The method of claim 8, further comprising transmitting, to the mobile device, a request for purchase of an insurance policy to indemnify a provider of the loan.

10. The method of claim 8, further comprising:
receiving a price of a product to be purchased via the mobile device;
identifying an account associated with the mobile device, wherein the account includes a purchase limit; and
determining the price exceeds the purchase limit, wherein the loan is used to facilitate purchase completion of the product.

11. A computer-readable medium having computer-executable instructions for execution by a processing system, the computer-executable instructions for acquiring a loan from a mobile platform, comprising:
instructions for receiving a loan request from a mobile device;
instructions for invoking a credit evaluation of a user of the mobile device responsive to receipt of the loan request, wherein the credit evaluation comprises an evaluation of a payment history of a mobile service account of the mobile device;
instructions for transmitting a request for an account identifier to the mobile device; and
instructions for depositing a loan amount of the loan request into an account having the account identifier.

12. The computer-readable medium of claim 11, further comprising instructions for transmitting, to the mobile device, a request for purchase of an insurance policy to indemnify a provider of the loan.

13. The computer-readable medium of claim 12, wherein purchase of the insurance policy includes an insurance premium that is pre-paid prior to depositing the loan amount into the account.

14. The computer-readable medium of claim 12, wherein purchase of the insurance policy includes an insurance premium that is paid subsequently to depositing the loan amount into the account.

15. The computer-readable medium of claim 11, further comprising:
instructions for receiving a price of a product to be purchased via the mobile device;
instructions for identifying an account associated with the mobile device, wherein the account includes a purchase limit; and
instructions for determining the price exceeds the purchase limit, wherein the loan is used to facilitate purchase completion of the product.

16. A mobile loan system comprising:
means for receiving authorization from a mobile device to acquire a loan from a financial institution;
means for communicating with a credit evaluation provider to receive a credit evaluation based upon a payment history associated with the mobile device;
means for communicating with an insurance provider in response to receipt of the credit evaluation;
means for communicating with the financial institution to receive an approval of the loan;
means for transmitting notice of the approval of the loan to the mobile device; and
a user database adapted to maintain a loan balance record.

17. The system of claim 16 further comprising:
means for communicating the loan balance record to a mobile network operator servicing the mobile device for generating a service invoice.

18. The system of claim 16 further comprising:
means for communicating with a merchant point of sale terminal to receive a purchase request identifying a purchase amount.

19. The system of claim 18 further comprising:
software adapted to compare the purchase amount to the loan balance record.

20. A method comprising:
associating a line of credit with a mobile device account;
receiving a loan request from a mobile device associated with the mobile device account;
identifying a balance on the line of credit greater than the loan request;
depositing a loan amount of the loan request into a user account;
generating a billing statement for at least a portion of the loan amount; and
sending the billing statement to a user associated with the mobile device account.

21. The method of claim 20 further comprising:
receiving an authorization from the mobile device to accept the loan amount.

22. The method of claim 20 further comprising:
receiving from the mobile device an account selection notice identifying the user account from among a plurality of possible accounts.

23. The method of claim 20 further comprising:
receiving a request to establish the line of credit; and
transmitting, to the mobile device, an offer to purchase an insurance policy to indemnify a provider of the line of credit,
wherein the step of associating a line of credit with a mobile device account is responsive to receiving an acceptance of the offer to purchase the insurance policy.

24. The method of claim 20 further comprising:
receiving a request to establish the line of credit; and
establishing the line of credit responsive to an evaluation of a payment history of the mobile device account.
